(19) United States
(12) Patent Application Publication
(10) Pub. No.: US 2011/0077949 A1
(43) Pub. Date: Mar. 31, 2011

(54) MICROPAYMENTS AGGREGATION

(75) Inventors: Hugo Olliphant, San Francisco, CA (US); Srikanth Nandiraju, Santa Clara, CA (US); Mehryar Mansoor, San Jose, CA (US)

(73) Assignee: eBay Inc., San Jose, CA (US)

(21) Appl. No.: 12/571,259

(22) Filed: Sep. 30, 2009

(51) Int. Cl. G06Q 30/00

(52) U.S. Cl. 705/1.1; 705/39; 705/30

(57) ABSTRACT

Various methods, apparatus, and systems are disclosed for improved micropayment arrangements that allow for versatile and efficient micropayments aggregation and distribution of funds. In accordance with one embodiment, a method of aggregating micropayments includes registering a plurality of seller accounts, each including content to be sold, and associating the content with a micropayment aggregation method, including pre-paid aggregation, post-paid aggregation, and time-delayed aggregation. The method further includes then charging a buyer account for purchases of content based on different micropayment aggregation methods associated with the content.

### BACKGROUND

1. Field of the Invention

The present invention generally relates to Internet commerce, and more particularly to methods, apparatus, and systems for micropayments aggregation and distribution of funds from Internet transactions.

2. Related Art

Internet commerce is growing rapidly, with much of the activity related to the sale of goods and services. Typically, merchants sell goods and services either directly using a credit card merchant account, or through a third party such as eBay, as one of the Internet auction houses. In addition to conventional goods and services, the development of the Internet has led to the growth of online content as a commercial focus.

Network-based (or online) vendors are typically heavily dependent on electronic payment services, and may accept a number of electronic payment instruments (e.g., credit cards, debit cards, and other electronic payment services (e.g., the PayPal online payment service)).

However, as there has been a recognized need for a content pay for use system wherein the customer can search the net for the desired content and then pay for only what is required, the often times relatively small payments required of pay for use has led to the term “micropayments”. A micropayment may be defined absolutely (e.g., in a range from 0.01 cents to $20) or more generally as a payment that is too small to be efficiently drawn from a conventional credit account (e.g., a credit card account).

A number of companies offer electronic payment (or funds transfer) services. Such electronic payment services naturally charge for the provision of such services, typically on a per-transaction basis, and often include fixed transaction charges. These transaction charges are further typically levied against a vendor. While such transaction charges are unattractive to vendors, in many instances the transaction charges are small in comparison to the total transaction value. Further, vendors regard the convenience benefits to both the purchaser and the vendor as outweighing the relevant cost.

However, as a total transaction value decreases, the per-transaction charge of course increases as a percentage of the total transaction value, and the attractiveness to the vendor of using such electronic payment services decreases. It is for this reason that vendors are often reluctant to accept electronic payment (e.g., via a credit card) where the total transaction value is small. The use of electronic payment services becomes particularly unattractive when the transaction costs begin to approach the profit margins associated with a transaction. The problem becomes more acute as the per item value decreases.

Furthermore, because of fragmentation in the content industry, users who desire to purchase content are often faced with subscribing to signing up to numerous different services or accounts, which further increases the burden to the user.

Accordingly, there is a growing need to address the problems of transaction charges, multiple signups, and inefficiencies associated with so called micropayments.

### SUMMARY

These needs are met by the present invention, which provides for improved micropayment arrangements that allow for versatile and efficient micropayments aggregation and distribution of funds.

In accordance with an embodiment of the invention, a method of aggregating micropayments includes registering a plurality of seller accounts, with each account including content to be sold, and associating the content with a micropayment aggregation method selected from the group including pre-paid aggregation, post-paid aggregation, and time-delayed aggregation. The method further includes charging a buyer account for purchases of content or other digitally delivered good, in one example from a single seller or a plurality of sellers, based on different micropayment aggregation methods associated with the content or seller.

In accordance with another embodiment of the invention, a method of aggregating micropayments further includes in addition to the above elements, registering a plurality of buyer accounts, and charging a buyer account for purchases of content based on different micropayment aggregation methods associated with the content or seller, wherein the purchase is made by a single user input via a user interface, wherein the buyer account is charged a threshold pre-payment value prior to purchase of content for pre-paid aggregation, wherein the buyer account is charged a threshold aggregated value after purchase of content for post-paid aggregation, and wherein the buyer account is charged a threshold aggregated value after a set time period after purchase of content for time-delayed aggregation. The method further includes aggregating micropayments from the plurality of buyer accounts into a single omnibus account, and then distributing funds from the single omnibus account to seller accounts after a threshold time limit.

In accordance with another embodiment of the invention, a micropayments aggregation server includes a seller database for storing a plurality of registered seller accounts and content associated with a micropayment aggregation method selected from the group including pre-paid aggregation, post-paid aggregation, and time-delayed aggregation; a buyer database for storing a plurality of registered buyer accounts; and a processor for charging a buyer account for purchases of content based on different micropayment aggregation methods associated with the content.

Advantageously, the present invention provides a versatile and efficient micropayments aggregation method, system, and apparatus that allow for a single buyer account to be used across different aggregation models, a one-click payment experience for purchases, and that reduces pre-payment commitments and signup and top-up friction.

These and other features and advantages of the present invention will be more readily apparent from the detailed description of the embodiments set forth below taken in conjunction with the accompanying drawings.

### BRIEF DESCRIPTION OF THE FIGURES

FIG. 1 illustrates a process flow of micropayment transactions, aggregated micropayments, and fund distributions between buyers, a micropayments aggregation account, and developers or sellers of content in accordance with an embodiment of the invention.

FIG. 2 illustrates a block diagram of a networked system configured to provide various micropayment transactions, various aggregated micropayments, and fund distributions between buyers, a micropayments aggregation account, and sellers in accordance with an embodiment of the invention.

FIG. 3 illustrates a block diagram of a computer system suitable for implementing one or more embodiments of the present disclosure.

FIG. 4 illustrates a process flow for providing various micropayment transactions and distributions from various aggregated micropayments in accordance with an embodiment of the invention.

FIGS. 5A-5C illustrate process flows for pre-paid micropayment aggregation, post-paid micropayment aggregation, and time-delayed micropayment aggregation, respectively, in accordance with embodiments of the invention.

FIGS. 6A-6D illustrate example buyer prompts at a buyer device for micropayment purchases of content from a seller site in accordance with embodiments of the invention.

Like element numbers in different figures represent the same or similar elements.

### DETAILED DESCRIPTION

Methods of micropayments aggregation include pre-paid aggregation, time-delayed aggregation, and post-paid aggregation, and depending on the merchant/seller or content, different aggregation methods may be desirable. The present invention provides systems, apparatus, and methods which allow a merchant to select a type of aggregation desired to be associated with the merchant and/or a product/content to be sold by the merchant while providing the user a simple interface for purchase of a product or content across all aggregation methods.

Various content to be purchased or online transactions involving micropayments are within the scope of the present invention, including but not limited to playing an online game, applications for mobile platforms, tips for a website, teaser content, donations, and payment for listening to music.

The pre-paid aggregation model refers to the method in which the buyer pre-pays a balance, which is then drawn down for each micropayment. Some services may call these types of accounts points, bucks, tokens, or some other such virtual currency.

The post-paid aggregation model refers to the method in which the account collects pledges of micropayments for purchases, and then demands payment from the pledger once a given threshold is reached.

The time-delay aggregation model refers to the method in which a buyer is charged for an item after some time period, with the hope that the buyer makes additional purchases within the time period.

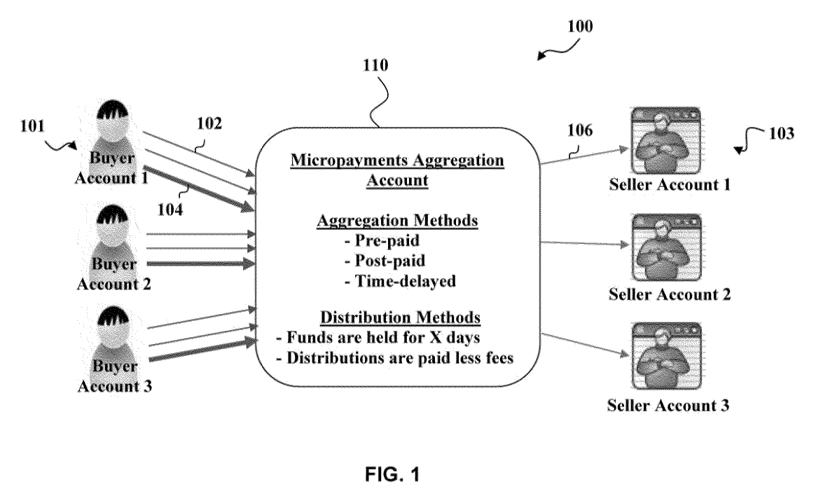

Referring now to the drawings which are only for purposes of illustrating embodiments of the present invention and not for purposes of limiting the same, FIG. 1 illustrates a process flow 100 of micropayment transactions 102, aggregated micropayments 104, and fund distributions 106 between buyer accounts 101, a micropayments aggregation account 110, and seller accounts 103 in accordance with an embodiment of the invention.

In one embodiment, buyers and sellers register with a micropayments aggregation server, and content to be sold or transactions are associated with an aggregation model by the seller or developer. When a buyer purchases an item or service from a seller, or makes a donation of some kind, the micropayments aggregation server determines which aggregation type is associated with the item, use, transaction, or seller of the item and aggregates or tracks the micropayment transactions 102 according to the associated aggregation method. Aggregated micropayments 104 from buyer accounts 101 may then be transferred into an omnibus account 110 and funds from the omnibus account later distributed to seller accounts 103. It is noted that buyers and sellers are treated as equivalent to donors and donation recipients in this document.

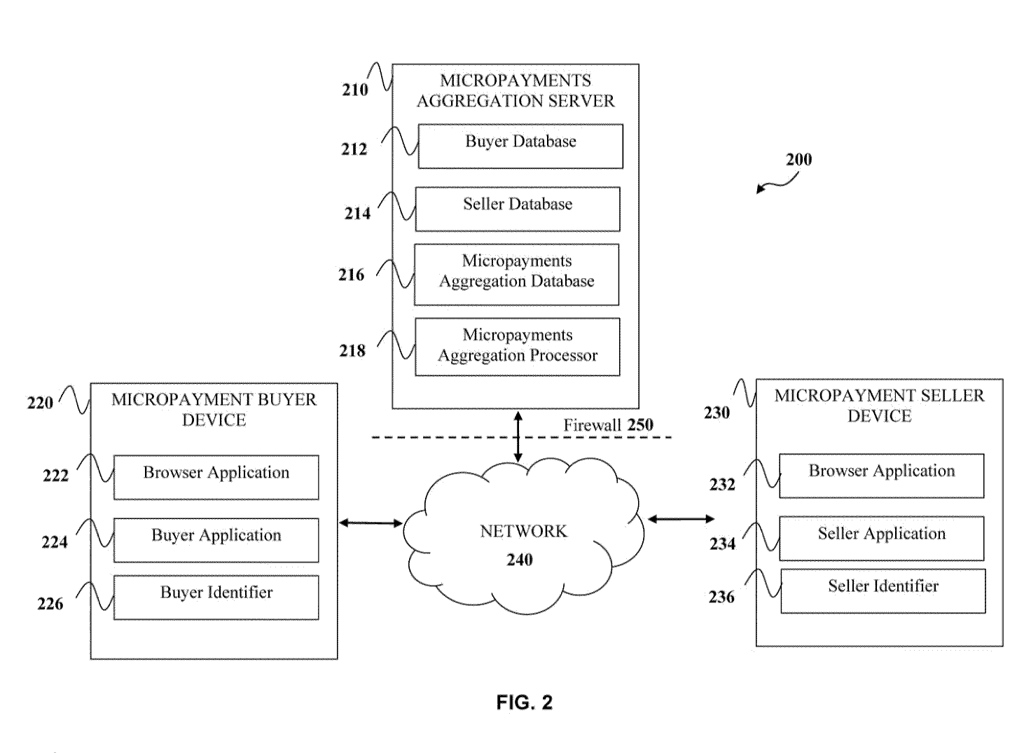

FIG. 2 illustrates a block diagram of a networked system 200 configured to provide various micropayment transactions between buyer devices, a micropayments aggregation server, and seller devices in accordance with an embodiment of the invention. As shown, system 200 includes a micropayments aggregation server 210, a micropayment buyer device 220, and a micropayment seller device 230 in communication over a network 240.

Network 240 may be implemented as a single network or a combination of multiple networks. For example, in various embodiments, network 240 may include the Internet or one or more intranets, landline networks, wireless networks, and/or other appropriate types of networks.

Seller device 230 may be implemented using any appropriate combination of hardware and/or software configured for wired and/or wireless communication over network 240. For example, in one embodiment, seller device 230 may be implemented as a personal computer of a user in communication with the Internet. In other embodiments, seller device 230 may be implemented as a wireless telephone, personal digital assistant (PDA), notebook computer, and/or other types of computing devices. Seller device 230 may also be part of its own computer network.

As shown, seller device 230 may include one or more browser applications 232 which may be used, for example, to provide a convenient interface to permit a seller to browse or publish information over network 240. For example, in one embodiment, browser application 232 may be implemented as a web browser configured to view or publish information over the Internet.

Seller device 230 also includes one or more seller applications 234 which may be used, for example, to provide seller-side processing for performing desired tasks in response to operations selected by the seller. In one embodiment, seller application 234 may display a seller user interface in connection with browser application 232 that is configured to allow the seller to select an aggregation method to be associated with the seller or with content. In one embodiment, the aggregation method associated with the seller or content may be one of pre-paid aggregation, post-paid aggregation, and time-delayed aggregation.

Seller device 230 may further include other applications as may be desired in particular embodiments to provide desired features to seller device 230. For example, in various embodiments, such other applications may include security applications for implementing seller-side security features, programmatic seller applications for interfacing with appropriate application programming interfaces (APIs) over network 240, or other types of applications.

As also shown in FIG. 2, seller device 230 may include one or more seller identifiers 236 which may be implemented, for example, as operating system registry entries, cookies associated with browser application 232, identifiers associated with hardware of seller device 230, or other appropriate identifiers. In one embodiment, seller identifier 236 may be used by aggregation server 210 to track selected aggregation methods, track fund distributions, associate a seller with a particular account maintained by the aggregation server, and the like.

Similar to seller device 230, buyer device 220 may be implemented using any appropriate combination of hardware and/or software configured for wired and/or wireless communication over network 240. For example, in one embodiment, buyer device 220 may be implemented, as a personal computer of a user in communication with the Internet. In other embodiments, buyer device 220 may be implemented as a wireless, telephone, personal digital assistant (PDA), notebook computer, and/or other types of computing devices. Buyer device 220 may also be part of its own computer network.

As shown, buyer device 220 may include one or more browser applications 222 which may be used, for example, to provide a convenient interface to permit a buyer to browse information and select items or content for purchase available over network 240. For example, in one embodiment, browser application 222 may be implemented as a web browser configured to view and/or select information available over the Internet.

Buyer device 220 also includes one or more buyer applications 224 which may be used, for example, to provide buyer-side processing for performing desired tasks in response to operations selected by the buyer.

Buyer device 220 may further include other applications as may be desired in particular embodiments to provide desired features to buyer device 220. For example, in various embodiments, such other applications may include security applications for implementing buyer-side security features, programmatic buyer applications for interfacing with appropriate application programming interfaces (APIs) over network 240, or other types of applications.

As also shown in FIG. 2, buyer device 220 may include one or more buyer identifiers 226 which may be implemented, for example, as operating system registry entries, Flash store objects, cookies associated with browser application 222, identifiers associated with hardware of buyer device 220, or other appropriate identifiers. In one embodiment, buyer identifier 226 may be used by aggregation server 210 to associate a buyer with a particular account maintained by the aggregation server 210.

Micropayments aggregation server 210 may be maintained, for example, by an online payment service provider (e.g., PayPal) offering flexible and efficient micropayment aggregation options to online merchant sellers and a simple user interface for the buyer. In one embodiment, the payment service provider may provide services in exchange for payment, such as by commission or a transaction fee, to be received over network 240 in one example. In one embodiment, aggregation server 210 may be provided by eBay, Inc. of San Jose, Calif.

In this regard, aggregation server 210 may maintain a plurality of buyer and seller accounts and includes a buyer database 212, a seller database 214, a micropayments aggregation database 216, and a micropayments aggregation processor 218 in one embodiment. Buyer and seller accounts may be associated with individual users or groups such as corporations or charitable organizations. In one example, buyer database 212 includes buyer account information, such as buyer identifiers, credit history, etc. In one example, seller database 214 includes seller account information, such as seller identifiers, selected aggregation methods, associated content, etc. In one example, micropayments aggregation database 216 includes account fund data including buyer account fund amounts, buyer micropayment transactions, buyer aggregated micropayments, fund distributions to sellers, etc. Aggregation server 210 may also have access to other data, such as tracking data, and/or data from third-parties such as eBay, Google, Yahoo, etc.

Aggregation server 210 is configured to communicate over network 240 with browser applications 222 and/or 232. For example, in one embodiment, a buyer or seller device may interact with aggregation server 210 through a browser application over network 240 in order to provide information related to selected aggregation method, selected content to be purchased, identifiers, and so on.

Aggregation server 210 includes a processor 218 configured to: register a plurality of seller accounts; associate content or a micropayment transaction with a micropayment aggregation method, including one of pre-paid aggregation, post-paid aggregation, and time-delayed aggregation; register a plurality of buyer accounts for funding a single omnibus account to aggregate micropayments from the plurality of buyer accounts; charge a buyer account for purchases of content from a plurality of sellers based on the micropayment aggregation method associated with the content or seller, wherein the purchase is made by a single user input via a user interface, wherein the buyer account is charged a threshold pre-payment value prior to purchase of content for pre-paid aggregation, wherein the buyer account is charged a threshold aggregated value after purchase of content for post-paid aggregation, and wherein the buyer account is charged a threshold aggregated value after a set time period after purchase of content for time-delayed aggregation. The processor 218 is further configured to aggregate micropayments from the plurality of buyer accounts into a single omnibus account; and to distribute funds from the single omnibus account to seller accounts after a threshold time limit.

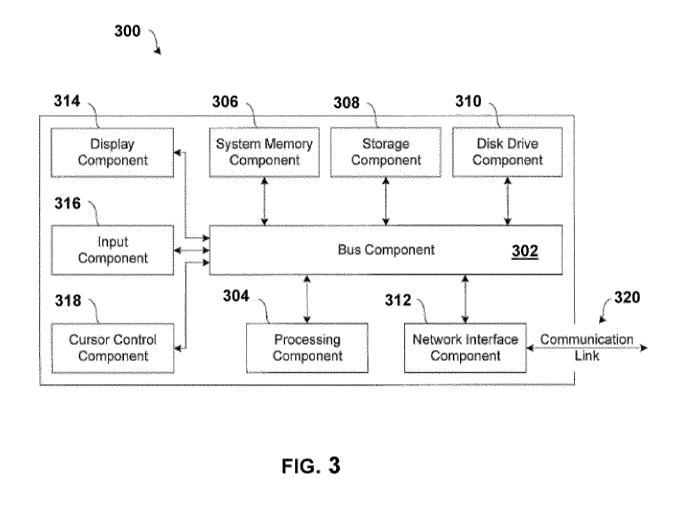

Referring now to FIG. 3 in conjunction with FIG. 2, a block diagram is illustrated of a computer system 300 suitable for implementing one or more embodiments of the present disclosure, including the seller device 230, the buyer device 220, and the aggregation server 210. In various implementations, the buyer device 220 may comprise a personal computing device capable of communicating with the network 240, such as a personal computer, laptop, cell phone, PDA. etc. the aggregation server 210 may comprise a network computing device, such as a network server, and the seller device 230 may comprise a network computing device, such as a network server and/or a personal computing device. Hence, it should be appreciated that each of the apparatus 210, 220, and 230 may be implemented at least in part by computer system 300 in a manner as follows.

In accordance with various embodiments of the present disclosure, computer system 300, such as a personal computer and/or a network server, includes a bus 302 or other communication mechanism for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., CRT or LCD), input component 316 (e.g., keyboard), and cursor control component 318 (e.g., mouse or trackball). In one implementation, disk drive component 310 may comprise a database having one or more disk drive components.

In accordance with embodiments of the present disclosure, computer system 300 performs specific operations by processor 304 executing one or more sequences of one or more instructions contained in system memory component 306. Such instructions may be read into system memory component 306 from another computer readable medium, such as static storage component 308 or disk drive component 310. In other embodiments, hard-wired circuitry may be used in place of or in combination with software instructions to implement the present disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, non-volatile media includes optical or magnetic disks, such as disk drive component 310, volatile media includes dynamic memory, such as system memory component 306, and transmission media includes coaxial cables, copper wire, and fiber optics, including wires that comprise bus 302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium. CD-ROM, any other optical medium, punch cards, paper tape, any other physical medium with, patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice embodiments of the present disclosure may be performed by computer system 300. In various other embodiments of the present disclosure, a plurality of computer systems 300 coupled by communication link 320 (e.g. network 240 of FIG. 2, such as a LAN, WLAN, PTSN, and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In one embodiment, a buyer device for selecting content to be purchased online comprises a network interface configured to allow communication between the buyer device, a seller device, and a micropayments aggregation server over a network, and a processor configured to submit buyer account information for registration with the micropayments aggregation server and selection of content to be purchased in a micropayment transaction.

In another embodiment, a seller device for submitting content to be purchased online comprises a network interface configured to allow communication between the seller device, a buyer device, and a micropayments aggregation server over a network, and a processor configured to submit seller account information for registration with the micropayments aggregation server, selection of micropayments aggregation methods/types, and submission of content to be purchased in a micropayment transaction.

In yet another embodiment, a micropayments aggregation server device for registering buyers, registering sellers, tracking micropayment transactions, aggregating micropayments, and distributing funds from aggregated micropayments comprises a buyer database for storing buyer information, a seller database for storing seller information, a micropayments aggregation database for storing micropayment and distribution information, and a network interface configured to allow communication between a seller device, a buyer device, and the aggregation server over a network. The server device further includes a processor configured to: register buyers, register sellers, and track aggregated buyer micropayments based upon selected seller aggregation methods.

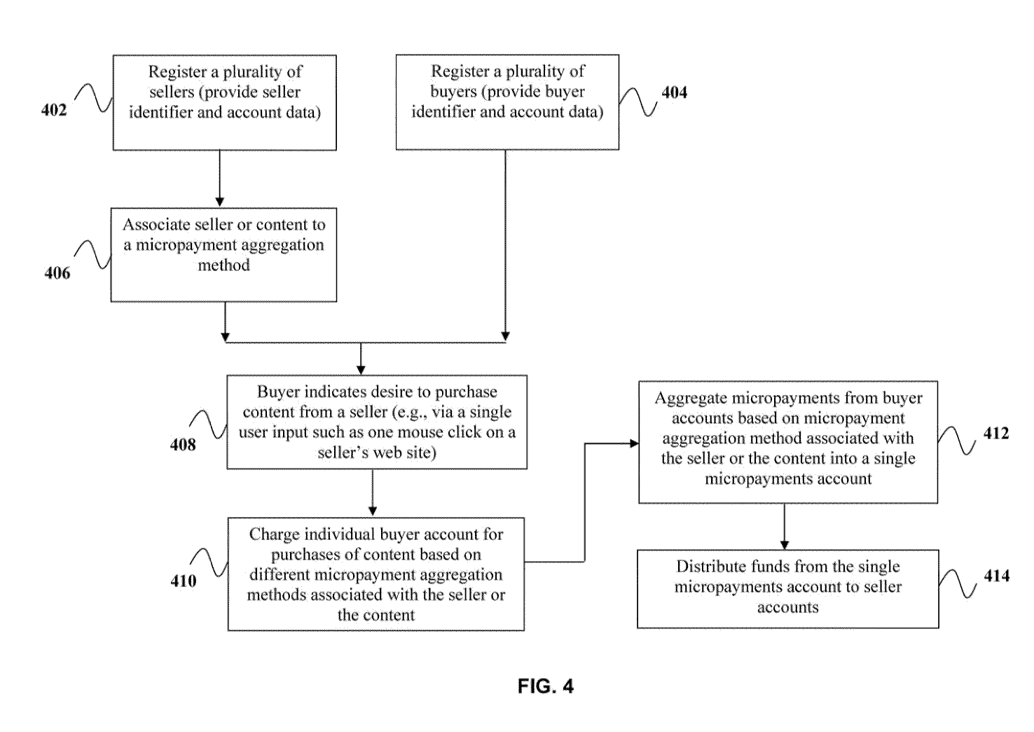

FIG. 4 illustrates a process flow for system 200 of FIG. 2 in which various micropayment transactions and distributions from various aggregated micropayments are provided in accordance with an embodiment of the invention. At steps 402 and 404, a plurality of sellers and a plurality of buyers, respectively, are registered by a micropayments aggregation server (such as server 210 of FIG. 2) to open respective seller and buyer accounts and to link and/or authenticate a user, a user's client computer, and a user's funding instrument. This may be done through login usernames, passwords, and/or computer identifiers. In this regard, it will be appreciated that the seller and buyer will provide account information to aggregation server 210 over network 240 through, for example, a secure connection between the aggregation server and respective seller and buyer devices. As a result of such registration, aggregation server 210 stores an identifier that may be used to identify the particular client device and associated account as having an account maintained by the aggregation server and/or a third party service provider. As previously described, the identifier may be implemented, for example, as one or more cookies, Flash store objects, operating system registry entries, hardware identifiers, or other types of identifiers.

In the registration process for a seller at step 406, a micropayment aggregation method is associated with the seller, content to be sold by the seller, use for content, or other micropayment transaction. In one example, the micropayment aggregation method is selected by the seller or developer from pre-paid aggregation, post-paid aggregation, and time-delayed aggregation. It is noted that a single seller can use more than one type of aggregation method, as the seller may associate different aggregation methods to different content to be sold. Advantageously, the present invention is operable at a micropayment transaction level, and any transaction can use any aggregation method.

At step 408, a buyer navigates to a seller's content and indicates a desire to purchase the content (such as by a single user input on a seller's website). At step 410, the buyer's account is “charged” for the purchase of the content based on the micropayment aggregation method associated with the seller of the content or the content itself. The micropayment transaction value can actually be charged to the buyer's account for pre-paid aggregation, or the cost may be tracked by the aggregation server for post-paid aggregation and time-delayed aggregation until a threshold value or threshold time, respectively, is met by the buyer. A plurality of buyers may follow similar steps as denoted by steps 408 and 410.

One type of post-paid aggregation service is a pledge system, in which purchase transactions are tracked and payment is later requested. Another type of post-paid aggregation service is a payment system, in which a buyer's funding source is required at the time of signup, and the funding source will be charged whenever a post-paid threshold value is met. This latter post-paid aggregation embodiment is an alternative to the time-delayed aggregation model, which may have lower transaction costs associated with it.

In other embodiments, a signup threshold decision process may be applied, which allows for buyer credit up to a signup threshold value and then requires the buyer to sign up for a micropayments account. The signup threshold decision process may be implemented in any of the pre-paid, post-paid, or time-delayed aggregation models.

At step 412, micropayments from a buyer account(s) are aggregated, and in one example are aggregated into a single omnibus account maintained by the payment service provider. In another example, the micropayments may be aggregated into individual buyer accounts. At step 414, funds from the single omnibus account or the individual buyer accounts are distributed to appropriate seller accounts based on the micropayment aggregation method associated with the seller or the content. In one embodiment, funds are distributed to seller accounts after a threshold number of days, such as thirty days, to prevent or reduce losses from charge-backs.

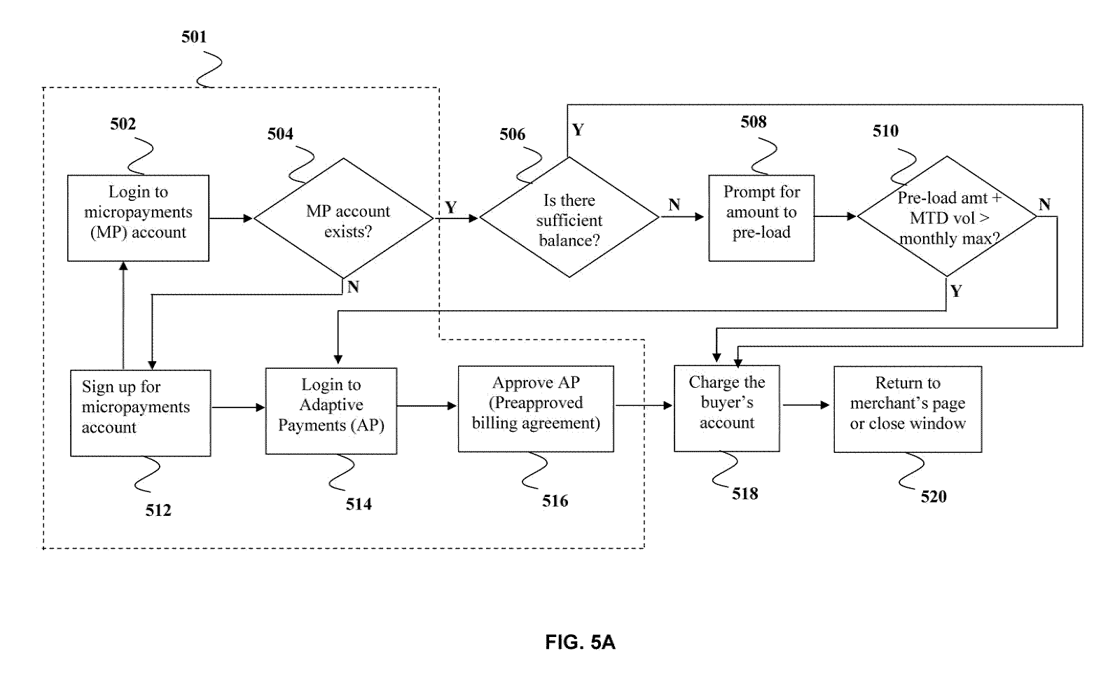

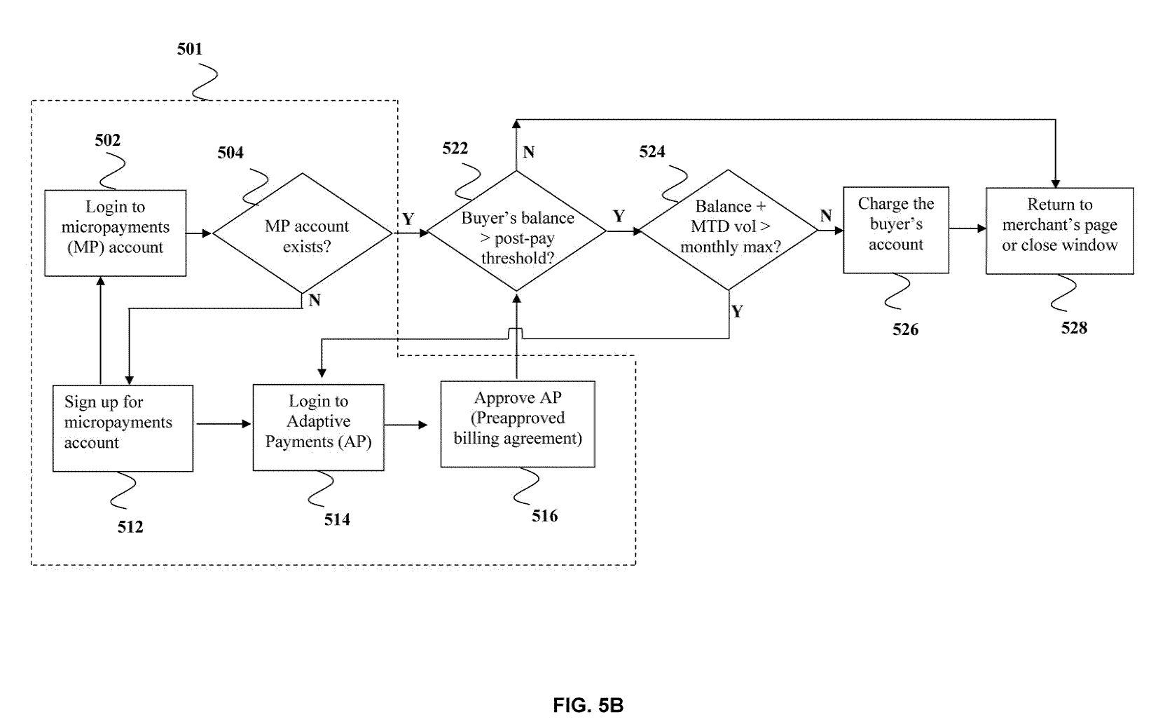

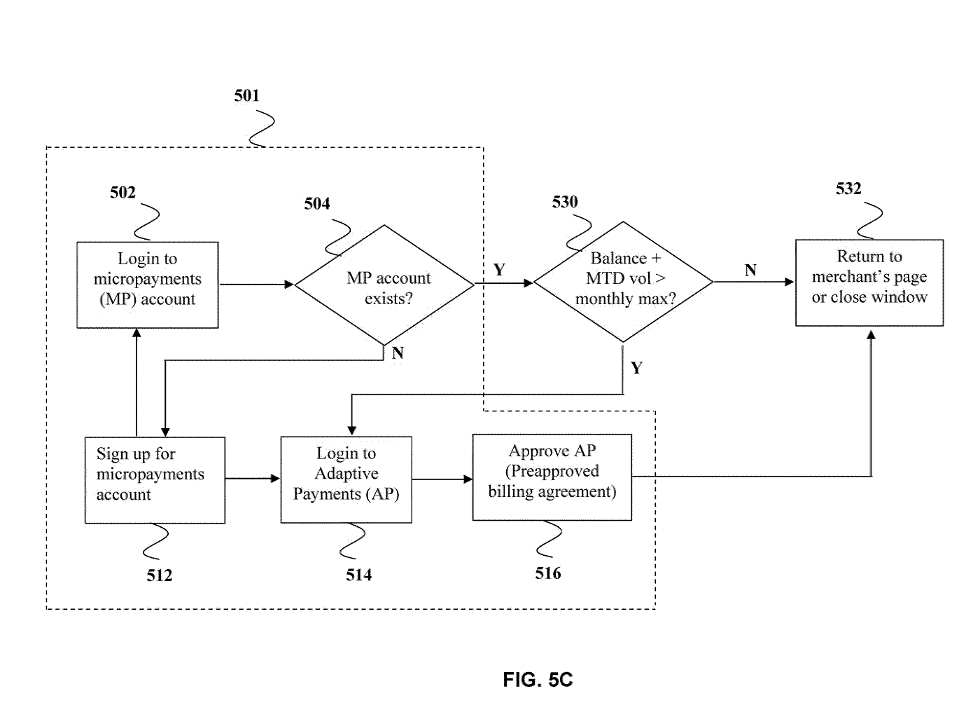

Referring now to FIGS. 5A-5C in conjunction with FIGS. 1-4, various process flows for micropayments aggregation server 210 of FIG. 2 are provided, in which pre-paid micropayment aggregation, post-paid micropayment aggregation, and time-delayed micropayment aggregation are utilized, respectively, in accordance with embodiments of the invention. All three process flows include a registration cycle 501 in which data about a buyer, a buyer client device, and a buyer account are obtained and linked. In one example, registration cycle 501 includes a login 502 to a micropayments account, a decision block 504 as to whether a micropayments account exits, a signup 512 for a micropayments account, a login 514 to a billing agreement for recurring charges, such as “Adaptive Payments” by PayPal, and a billing agreement approval block 516. Other registration cycles may also be used. These buyer micropayment accounts may be maintained by aggregation server 210.

FIG. 5A illustrates a process flow for a pre-paid micropayments aggregation model upon a purchase request from a buyer. From decision block 504, if a micropayments account does exist from login, the aggregation server determines at decision block 506 whether there is a sufficient balance in the buyer's account for the requested purchase. If yes, the buyer's account is charged at block 518 and the process returns to the merchant's page and/or closes the purchase tab at block 520. If no, a prompt is provided to the buyer to pre-load the buyer's account at block 508. The server then checks at decision block 510 whether the pre-load amount and the month to date volume of purchases exceeds a maximum threshold monthly volume. Decision block 510 is used to prevent or reduce fraud in these micropayment transactions. If no, the buyer's account is charged at block 518 and the process returns to the merchant's page and/or closes the purchase tab at block 520. If yes, the server again goes through a part of the registration cycle to gain approval for a purchase above the maximum threshold monthly volume. From billing approval block 516, the buyer's account is charged a pre-paid threshold value at block 518 and the process returns to the merchant's page and/or closes the purchase tab at block 520.

A sample use case for pre-paid micropayments aggregation includes an online game, which offers players an option to purchase special armor for $0.25. If the user has not signed up with the micropayments aggregation server/service provider or does not have a micropayment account with a balance, the user is required to create a micropayment account with a minimum balance, for example $5. A $0.25 transaction for the purchase of armor will be deducted from this balance. Advantageously, the user's micropayment account and balance can be used across other micropayment services as well, which can assuage concerns from users around paying the pre-payment for the particular micropayment transaction.

FIG. 5B illustrates a process flow for a post-paid micropayments aggregation model upon a purchase request from a buyer. From decision block 504, if a micropayments account does exist from login, the aggregation server determines at decision block 522 whether the buyer account's balance exceeds a post-paid threshold value with the purchase request. If no, the server keeps track of the purchase value and the process returns to the merchant's page and/or closes the purchase tab at block 528. If yes, the server then checks at decision block 524 whether the buyer account's balance with purchase and the month to date volume of purchases exceeds a maximum threshold monthly volume. Decision block 524 is used to prevent or reduce fraud in these micropayment transactions. If no, the buyer's account is charged at block 526 and the process returns to the merchant's page and/or closes the purchase tab at block 520. If yes, the server again goes through a part of the registration cycle to gain approval for a purchase above the maximum threshold monthly volume. From billing approval block 516, the server determines at decision block 522 whether the buyer account's balance exceeds a post-paid threshold value with the purchase request.

A sample use case for post-paid micropayments aggregation includes a blog having a link at the end of a teaser paragraph stating, “Read the rest of this for $0.05.” The micropayments aggregation server/service provider can capture the $0.05 for the next time the user's account is charged for a micropayment purchase with any merchant, regardless of the aggregation method that a merchant is using. Additionally, the aggregation server/service provider can allow the user to accrue outstanding transaction charges up to a threshold amount, for example $3, before a payment is required. Accordingly, for a user who purchases a 60^{th} article to reach the threshold, the micropayments aggregation server will either charge $3 to the user if the user has already signed up or will require the user to sign up.

FIG. 5C illustrates a process flow for a time-delayed micropayments aggregation model upon a purchase request from a buyer. From decision block 504, if a micropayments account does exist from login, the aggregation server determines at decision block 530 whether the buyer account's balance with purchase and the month to date volume of purchases exceeds a maximum threshold monthly volume. Decision block 530 is used to prevent or reduce fraud in these micropayment transactions. If no, the server keeps track of the purchase value and the process returns to the merchant's page and/or closes the purchase tab at block 532. If yes, the server again goes through a part of the registration cycle to gain approval for a purchase above the maximum threshold monthly volume. From billing approval block 516, the process returns to the merchant's page and/or closes the purchase tab at block 532. After a threshold time period, the buyer's micropayment transactions are aggregated and the buyer's account is charged.

A sample use case for time-delayed micropayments aggregation includes the selling of mobile device applications for $2, in one example. In order to purchase the application, the user must be signed up for a micropayments account, and when the user makes a purchase, the user may be charged up to a threshold time period, for example 72 hours, after the purchase is made.

In all three process flows described above with respect to FIGS. 5A-5C, control may be returned to the seller or merchant at the end of a micropayment purchase or messaging flow, in one example, by either signaling a page refresh for the merchant's webpage or flagging the merchant's webpage that a payment (or other action) has been completed.

Furthermore, although the three process flows described above illustrate an authentication step for each top-up, as shown by a login to adaptive payments block 514 from a decision block 510, 524, or 530, other alternatives are possible. For example, top-ups could be automatic with no authentication required, or authentication may occur through a required personal identification number (PIN) that was created during signup. Other authentication methods may also be used.

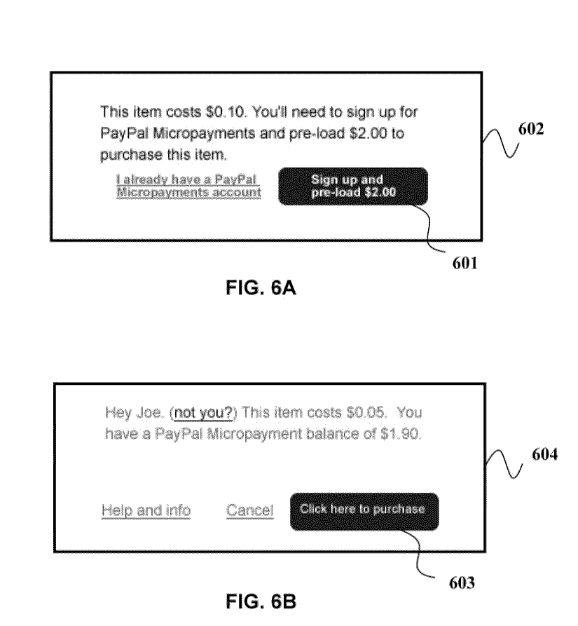

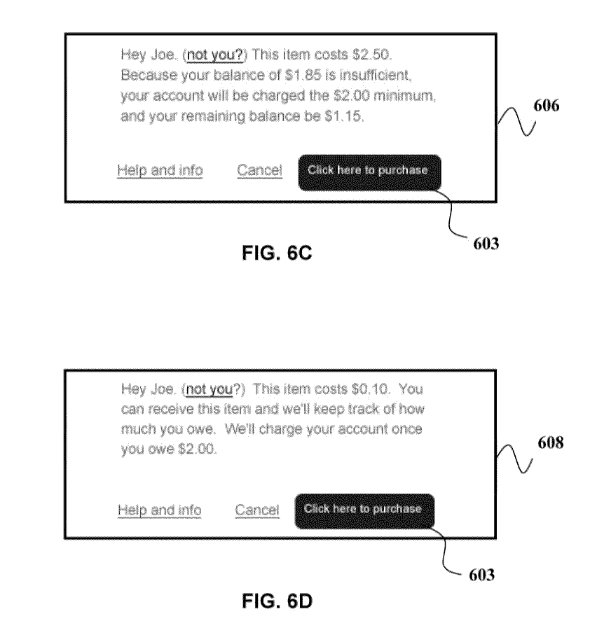

Referring now to FIGS. 6A-6D, example buyer prompts are illustrated at a buyer device for micropayment purchases of content from a seller site in accordance with embodiments of the invention. FIG. 6A illustrates a prompt 602 for a buyer upon a request to purchase an item associated with a pre-paid aggregation model. The aggregation server detects that the buyer is not registered to a micropayments account and provides a sign up and pre-load button 601.

FIG. 6B illustrates a prompt 604 for a buyer upon a request to purchase an item again associated with a pre-paid aggregation model. The aggregation server detects that the buyer is registered, has a sufficient balance to cover the purchase, and provides a one-click purchase button 603.

FIG. 6C illustrates a prompt 606 for a buyer upon a request to purchase an item associated with a time-delayed aggregation model. The aggregation server detects that the buyer is registered but that the purchase value exceeds the buyer account's balance. The aggregation server prompts the buyer that the account will be charged a threshold value and provides a one-click purchase button 603. After a threshold time period, the server charges the buyer's account the threshold value. The threshold time period may be in the order of hours or days to check if additional items are purchased in order to aggregate additional micropayment charges.

FIG. 6D illustrates a prompt 608 for a buyer upon a request to purchase an item associated with a post-paid aggregation model. The aggregation server detects that the buyer is registered and the purchase would not cause the aggregated purchases to exceed a post-paid threshold value (e.g., $2.00), and then provides a one-click purchase button 603.

Buyer prompts at the buyer device may be displayed by a browser application, and the user interface at the buyer device may be configured to respond to commands provided by a user through a suitable user input device of the buyer device, such as a mouse, keyboard, or other input device. Although not shown, seller prompts at the seller device may also be displayed by a browser application, and the user interface at the seller device may be configured to respond to commands provided by a user through a suitable user input device of the seller device, such as a mouse, keyboard, or other input device to easily select a micropayment aggregation method for the seller or content. For example, a seller interface allows the seller to choose from different micropayment aggregation options, including but not limited to a pre-paid aggregation button, a post-paid aggregation button, and a time-delayed aggregation button in one example. It is also noted that an aggregation model may be associated to content and various aggregation models may then be associated to a seller or the seller's website.

Advantageously, the buyer may purchase content (and the seller may select a micropayments aggregation method) with a single user input (such as by a single click of a mouse) regardless of the micropayment aggregation method selected by the seller of the content to be purchased. Advantageously, the present invention further provides a versatile and efficient micropayments aggregation method, system, and apparatus that allow for a single buyer account to be used across different aggregation models, a one-click payment experience for purchases, and that reduces pre-payment commitments and signup and top-up friction.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of aggregating micropayments, the method comprising:
registering a plurality of seller accounts, each including content to be sold;
associating the content with a micropayment aggregation method selected from a group including pre-paid aggregation, post-paid aggregation, and time-delayed aggregation; and
charging a buyer account for purchases of content based on different micropayment aggregation methods associated with the content.

2. The method of claim 1, wherein the buyer account is charged a threshold pre-payment value prior to purchase of content for pre-paid aggregation, wherein the buyer account is charged a threshold aggregated value after purchase of content for post-paid aggregation, and wherein the buyer account is charged an aggregated value after a threshold time period after purchase of content for time-delayed aggregation.

3. The method of claim 2, wherein threshold values for pre-paid aggregation, post-paid aggregation, and time-delayed aggregation are preset by a seller.

4. The method of claim 1, wherein the pre-paid aggregation includes a minimum pre-payment value or top-up payment value of $2, the post-paid aggregation includes a minimum aggregated value of $3, and the time-delayed aggregation includes a minimum aggregated value of $1.

5. The method of claim 1, wherein the buyer account is charged for a purchase with a single user input from a user interface.

6. The method of claim 1, further comprising registering a buyer account to fund a single account for purchases from the plurality of sellers.

7. The method of claim 1, further comprising funding a single omnibus account with funds from a plurality of buyer accounts.

8. The method of claim 7, further comprising distributing funds from the single omnibus account to seller accounts after a threshold number of days.

9. The method of claim 7, further comprising distributing funds from the single omnibus account to seller accounts based on the registered micropayment aggregation method associated with the seller accounts.

10. The method of claim 7, further comprising distributing funds from the single account to a seller account substantially immediately after purchase of content, when a threshold aggregated value is reached after purchase of content, or after a set time period after purchase of content.

11. A method of aggregating micropayments, the method comprising:
registering a plurality of seller accounts, each including content to be sold;
associating the content with a micropayment aggregation method selected from a group including pre-paid aggregation, post-paid aggregation, and time-delayed aggregation;
registering a plurality of buyer accounts;
charging a buyer account for purchases of content based on different micropayment aggregation methods associated with the content, wherein the purchase is made by a single user input via a user interface, wherein the buyer account is charged a threshold pre-payment value prior to purchase of content for pre-paid aggregation, wherein the buyer account is charged a threshold aggregated value after purchase of content for post-paid aggregation, and wherein the buyer account is charged a threshold aggregated value after a set time period after purchase of content for time-delayed aggregation;
aggregating micropayments from the plurality of buyer accounts into a single omnibus account; and
distributing funds from the single omnibus account to seller accounts after a threshold time limit.

12. A micropayments aggregation server, comprising:
a seller database for storing a plurality of registered seller accounts and content associated with a micropayment aggregation method selected from a group including pre-paid aggregation, post-paid aggregation, and time-delayed aggregation;
a buyer database for storing a plurality of registered buyer accounts; and
a processor for charging a buyer account for purchases of content based on different micropayment aggregation methods associated with the content.

13. The server of claim 12, wherein the processor charges the buyer account:
a threshold pre-payment value prior to purchase of content for pre-paid aggregation;
a threshold aggregated value after purchase of content for post-paid aggregation; and
an aggregated value after a threshold time period after purchase of content for time-delayed aggregation.

14. The server of claim 12, wherein the pre-paid aggregation includes a minimum pre-payment value or top-up payment value of $2, the post-paid aggregation includes a minimum aggregated value of $3, and the time-delayed aggregation includes a minimum aggregated value of $1.

15. The server of claim 12, wherein the processor charges the buyer account for a purchase based upon a single user input from a user interface.

16. The server of claim 12, wherein the seller database includes seller account data and the buyer database includes buyer account data.

17. The server of claim 12, further comprising a micropayments aggregation database for storing data related to a plurality of aggregated micropayments in a single omnibus account.

18. The server of claim 17, wherein the processor distributes funds from the single omnibus account to seller accounts after a threshold number of days.

19. The server of claim 17, wherein the processor distributes funds from the single omnibus account to seller accounts based on the micropayment aggregation method associated with the sellers.

20. The server of claim 17, wherein the processor distributes funds from the single omnibus account to a seller account substantially immediately after purchase of content, when a threshold aggregated value is reached after purchase of content, or after a set time period after purchase of content.
